(19) United States
(12) Patent Application Publication
(10) Pub. No.: US 2025/0368057 A1
(43) Pub. Date: Dec. 4, 2025

(54) BATTERY RETROFIT KIT

(71) Applicant: Briggs & Stratton, LLC, Wauwatosa, WI (US)

(72) Inventors: Stephen Bryan Avery, Milwaukee, WI (US); Nathan Jasinski, Wauwatosa, WI (US)

(73) Assignee: Briggs & Stratton, LLC, Wauwatosa, WI (US)

(21) Appl. No.: 19/222,907

(22) Filed: May 29, 2025

Related U.S. Application Data
(60) Provisional application No. 63/653,085, filed on May 29, 2024.

(51) Int. Cl. B60L 50/64; B60R 16/02; H01M 10/0525; H01M 10/46; H01M 50/249; H01M 50/298

(52) U.S. Cl. CPC B60L 50/64; B60R 16/0207; H01M 10/0525; H01M 10/46; H01M 50/249; H01M 50/298; B60L 2200/22; H01M 2220/20

(57) ABSTRACT

A battery retrofit kit for a golf cart includes a base having a mounting surface, a lithium-ion battery supported on the mounting surface, a battery charger coupled to the base, and a retrofit controller coupled to the base.

### CROSS-REFERENCE TO RELATED PATENT APPLICATIONS

This application claims the benefit of and priority to U.S. Provisional Patent Application No. 63/653,085, filed on May 29, 2024, which is incorporated herein by reference in its entirety.

### BACKGROUND

Golf carts typically include one or more electric drive or traction motors that are powered by a battery.

### SUMMARY

In some aspects, the present disclosure relates to a battery retrofit kit for a golf cart, including: a base including a mounting surface and supportable by the golf cart; a lithium-ion battery supported on the mounting surface; a battery charger coupled to the base; and a retrofit controller coupled to the base.

In some aspects, the present disclosure relates to a battery retrofit kit for a golf cart, including: a base including a mounting surface and supportable by the golf cart; a lithium-ion battery supported on the mounting surface; a battery charger coupled to the mounting surface; a retrofit controller coupled to the mounting surface; and a wiring harness including a first electrical connection between the lithium-ion battery and the retrofit controller.

In some aspects, the present disclosure relates to a method of retrofitting a power source to a golf cart, the golf cart including a frame and a battery supported on the frame, the method including: after removing the battery from the frame, supporting on the frame a base having a mounting surface; supporting a lithium-ion battery on the mounting surface; coupling a battery charger to the base; and coupling a retrofit controller to the base.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a top, front, left perspective view of a retrofit assembly, according to an exemplary embodiment;

FIG. 2 is a top, front, right perspective view of the retrofit assembly of FIG. 1;

FIG. 3 is a top, back, right perspective view of the retrofit assembly of FIG. 1;

FIG. 4 is a bottom, front, right perspective view of the retrofit assembly of FIG. 1;

FIG. 5 is a bottom, front, right perspective view of the retrofit assembly of FIG. 1 without base support brackets;

FIG. 6 is a schematic illustration of an electrical assembly of a golf cart including the retrofit assembly of FIG. 1;

FIG. 7 is a top, front, left perspective view of a retrofit assembly with a battery charger and a retrofit controller externally mounted, according to an exemplary embodiment;

FIG. 8 is a top, front, right perspective view of the retrofit assembly of FIG. 7;

FIG. 9 is a top view of the retrofit assembly of FIG. 7;

FIG. 10 is a top, front, right perspective view of a retrofit assembly with a battery charger and a retrofit controller mounted on a sidewall, according to an exemplary embodiment;

FIG. 11 is a top, front, left perspective view of the retrofit assembly of FIG. 10;

FIG. 12 is a top view of the retrofit assembly of FIG. 10;

FIG. 13 is a top, front, left perspective view of a retrofit assembly without sidewalls;

FIG. 14 is a top, back, left perspective of the retrofit assembly of FIG. 13;

FIG. 15 is a top view of the retrofit assembly of FIG. 13;

FIG. 16 is a top, front, left perspective view of a base assembly of a retrofit assembly without sidewalls or a perimeter wall;

FIG. 17 is a perspective view of a battery compartment on a golf cart;

FIG. 18 is a perspective view of the battery compartment of FIG. 17 with a base assembly installed; and

FIG. 19 is a perspective view of the battery compartment of FIG. 17 with a retrofit assembly installed.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Conventional golf carts are typically powered by a lead acid battery that is mounted within a battery compartment or cavity (e.g., under a seat of the golf cart). Lead acid batteries generally have lower energy density than lithium-ion batteries, which results in lead acid batteries defining a larger size and weight when compared to a lithium-ion batteries for the same energy capacity. It follows that when retrofitting golf carts having lead acid batteries with lithium-ion batteries, the size and mounting configuration for the lithium-ion batteries differs from the existing lead acid batteries.

The present disclosure provides a retrofit assembly or kit for a golf cart that enables a lithium-ion battery to be efficiently installed in replacement of a lead acid battery. For example, the retrofit kit includes a mounting assembly that supports a lithium-ion battery, a battery charger, and a retrofit controller. The mounting assembly may be a pre-formed structure to which the battery, the battery charger, and the retrofit controller are coupled to form the retrofit kit, which may then be efficiently installed on the golf cart as a single unit.

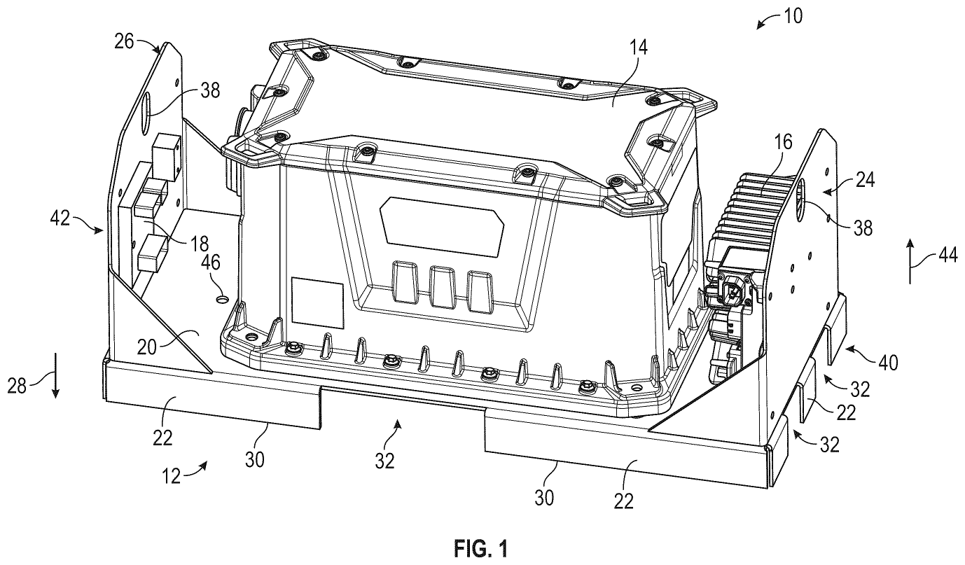

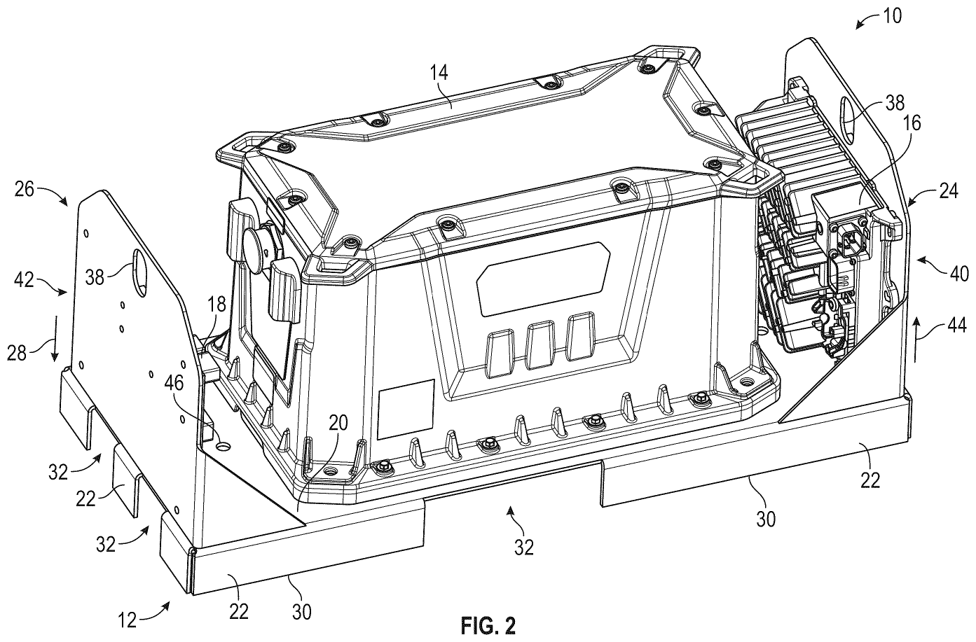

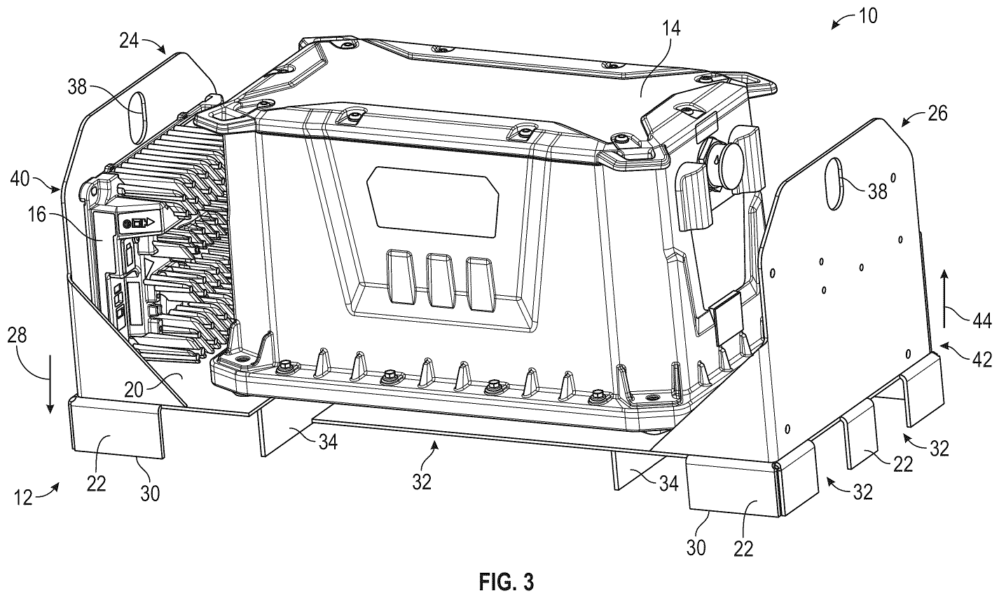

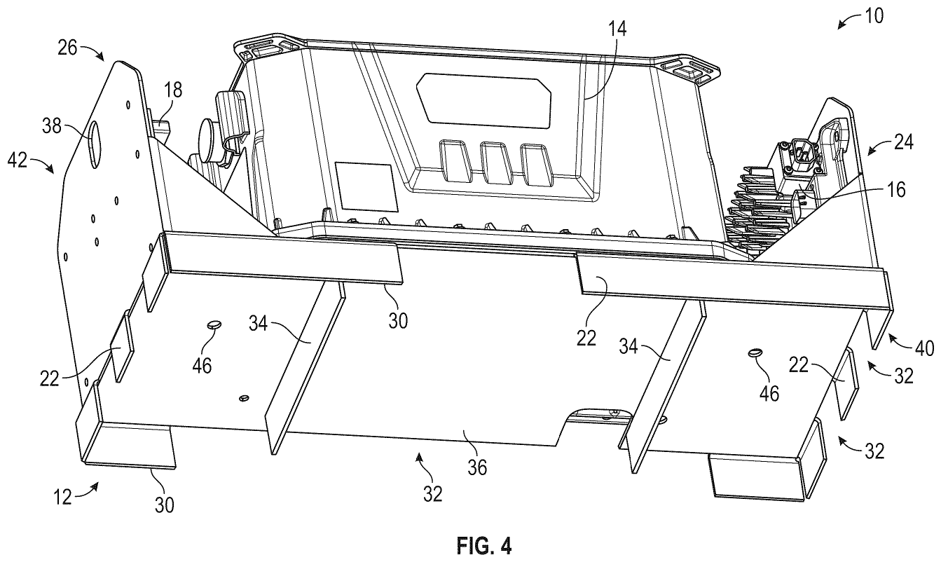

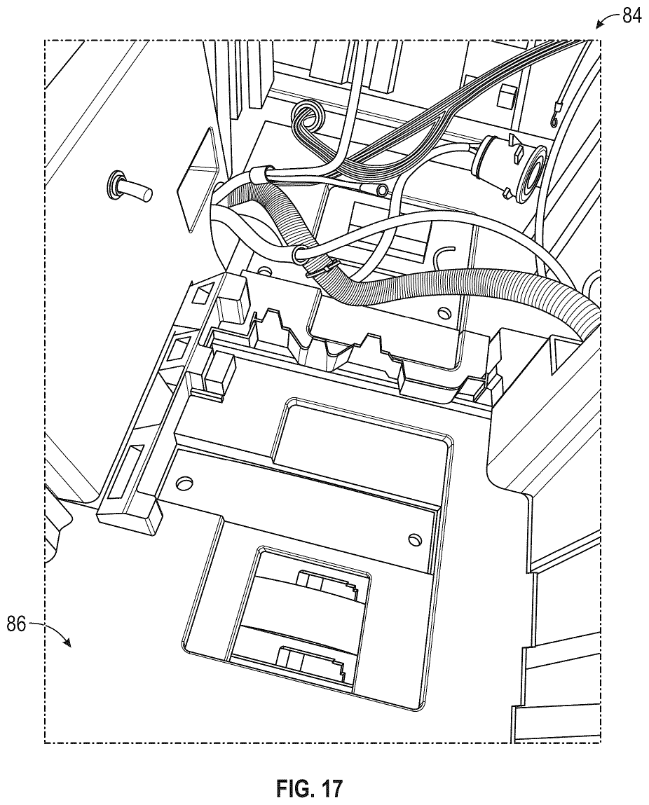

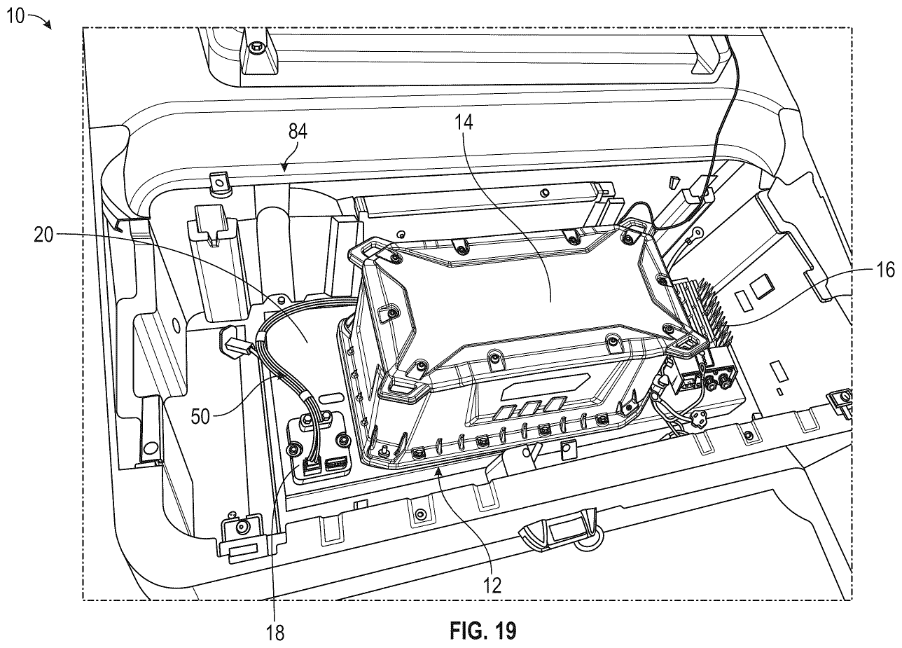

FIGS. 1-4 show a retrofit assembly or kit 10 for a golf cart, according to an exemplary embodiment. In general, the retrofit kit 10 is designed to be mounted or installed within a battery compartment, cavity, or enclosure on a golf cart (see, e.g., FIGS. 17-19). In some embodiments, the battery compartment on the golf cart defines a cavity that is generally in the shape of a rectangular prism, and the retrofit kit 10 is shaped to fit within the cavity defined by the battery compartment. In some embodiments, the retrofit kit 10 may be installed within a differently shaped cavity.

The retrofit kit 10 includes a mounting structure or base assembly 12, a battery 14, a battery charger 16, and a retrofit controller 18. In general, the base assembly 12 defines a framework that supports the battery 14, the battery charger 16, and the retrofit controller 18 as a single unit that may be efficiently installed within the battery compartment of a golf cart. The base assembly 12 includes an elevated platform or mounting surface 20, a perimeter wall 22, a first sidewall 24, a second sidewall 26. The battery 14 is coupled to and/or supported on the mounting surface 20, and the perimeter wall 22 is arranged around a periphery of the mounting surface 20. The perimeter wall 22 extends away from the mounting surface 20 in a first direction 28 (e.g., downward from the perspective of FIG. 1). When the retrofit kit 10 is installed within a battery compartment, a bottom surface 30 of the perimeter wall 22 (e.g., a surface arranged generally parallel to and furthest from the mounting surface 20) engages a mounting surface of the battery compartment. Because the bottom surface 30 is spaced from the mounting surface 20 in the first direction 28, the perimeter wall 22 acts to raise the mounting surface 20 off of the mounting surface. In some embodiments, the mounting surface 20 is raised above the mounting surface by the perimeter wall 22 so as to not interfere with existing bracketry within the battery compartment on the golf cart.

In the illustrated embodiment, the perimeter wall 22 includes one or more cutouts 32 formed therein. In some embodiments, each side (e.g., front, rear, left, and right) of the perimeter wall 22 include at least one cutout 32 formed therein. In general, the cutouts 32 may provide a channel or pathway through which components (e.g., wires, wiring harness, fluid-routing lines, etc.) may be routed. It should be appreciated that the cutouts 32 may separate the perimeter wall 22 into discrete wall sections that extend around the perimeter of the mounting surface 20 and the discrete wall sections combine to collectively form the perimeter wall 22.

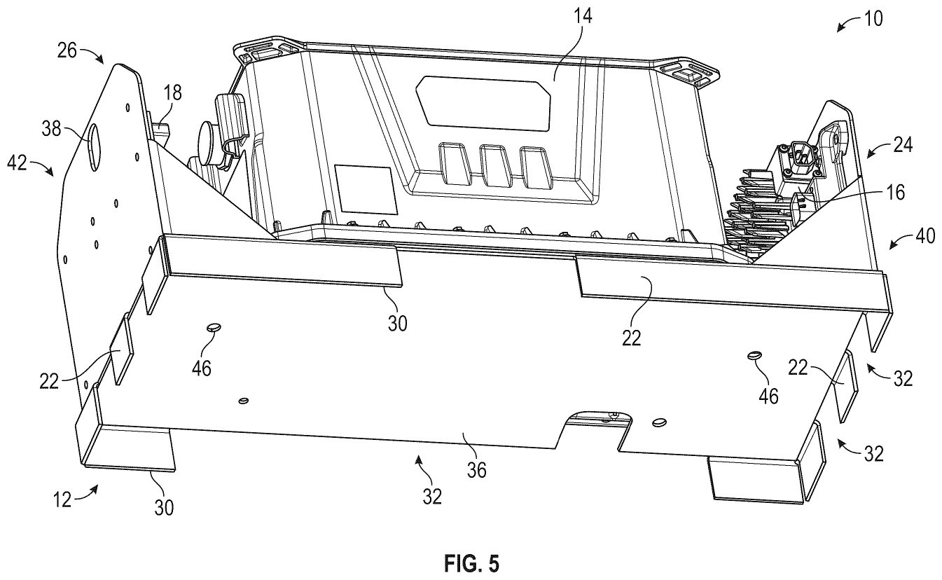

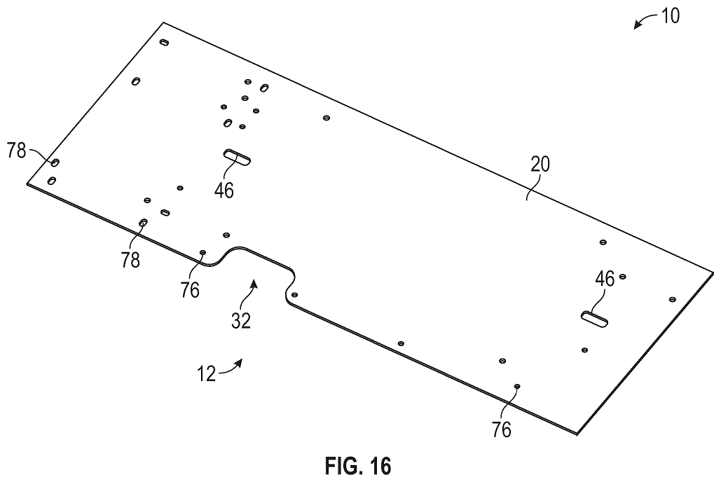

In some embodiments, the base assembly 12 includes one or more base support plates 34 that are coupled to a bottom or lower surface 36 of the mounting surface 20 (e.g., a surface opposite to the surface on which the battery 14 is supported). In the illustrated embodiment, the base assembly 12 includes a pair of the base support plates 34 that are separated from one another in a longitudinal direction (e.g., a direction parallel to the length or base direction defined by the rectangular shape of the bottom surface 36). The support plates 34 extend downwardly from the bottom surface 36 in the first direction 28 and also extend along a lateral direction (e.g., a direction parallel to the width or side direction defined by rectangular shape defined by the bottom surface 36). The support plates 34 are both arranged inwardly from the perimeter wall 22 and outwardly from a centerline defined along the lateral direction of the bottom surface 36. In some embodiments, the base assembly 12 may include more or less than two of the support plates 34. In some embodiments, the base assembly 12 may not include the support plates 34 (see, e.g., FIGS. 5 and 16).

With continued reference to FIGS. 1-4, each of the first sidewall 24 and the second sidewall 26 includes a lifting aperture 38. In general, the lifting apertures 38 provide connection points for a lift device (e.g., a crane, a hoist, or an equivalent lift device) to enable the base assembly 12, and components coupled thereto, to be lifted and lowered into the battery compartment on a golf cart. In the illustrated embodiment, the first sidewall 24 is coupled to and extends from a first side 40 of the mounting surface 20, and the second sidewall 26 is coupled to and extends from a second side 42 of the mounting surface 20 opposite to the first side 40. The first sidewall 24 and the second sidewall 26 both extend away from the mounting surface 20 in a second direction 44, which is opposite to the first direction 28 that the perimeter wall 22 extends away from the mounting surface 20.

In the illustrated embodiment, the battery charger 16 is coupled/mounted to the first sidewall 24. Specifically, the battery charger 16 is coupled to an inner surface of the first sidewall 24 so that the battery charger 16 faces the battery 14. In other words, the battery charger 16 is not coupled to an externally-facing surface of the first sidewall 24. In some embodiments, the battery charger 16 is configured to receive input power (e.g., AC power from a utility connection) and convert the input power to DC power that is supplied to the battery 14 to recharge the battery 14. The retrofit controller 18 is coupled/mounted to the second sidewall 26. Specifically, the retrofit controller 18 is coupled to an inner surface of the second sidewall 26 so that the retrofit controller 18 faces the battery 14. In other words, the retrofit controller 18 is not coupled to an externally-facing surface of the second sidewall 26.

In some embodiments, the base assembly 12 includes on or more mounting apertures 46 that aid in securing the battery 14 to the base assembly 12. For example, the mounting surface 20 includes a pair of mounting apertures 46, with one of the mounting apertures 46 being separated or spaced along the longitudinal direction so that one of the mounting apertures 46 is arranged outwardly from each side of the battery 14. In some embodiments, each of the mounting apertures 46 is configured to receive a component of a battery latching assembly. For example, each of the mounting apertures 46 may receive a coupling rod (e.g., a J-hook) and a strap may be fastened to the coupling rods so that the strap engages the top of the battery 14 and holds the battery 14 on the mounting surface 20.

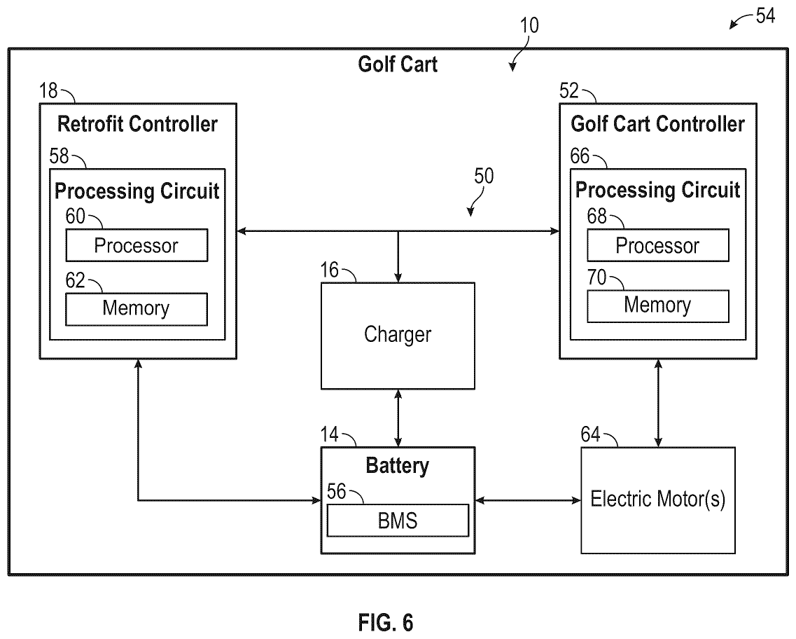

Turning to FIG. 6, the retrofit kit 10 includes a wiring harness 50 that provides electrical connections between the battery 14, the retrofit controller 18, and a golf cart controller 52 of a golf cart 54. In general, the retrofit controller 18 is configured to communicate signals from the battery 14 (e.g., from a battery management system (BMS) 56 of the battery 14) to the golf cart controller 52 and communicate signals from the golf cart controller 52 to the BMS 56 to facilitate operation of the golf cart 54 after the retrofit kit 10 has been installed. Specifically, the use of the battery 14 (i.e., a lithium-ion battery) including the BMS 56 may bring about a need for a controller to communicate signals to and from the BMS 56, and to and from the golf cart controller 52. Conventional lead-acid batteries do not include a BMS, so the retrofit kit 10 may solve a need for signal communication (e.g., over a CAN network) between the various components by including the retrofit controller 18. In some embodiments, the BMS 56 may communicate directly with the charger 16 and to the golf cart controller 52 without the retrofit controller 18 acting as an intermediary. For example, the BMS 56 and/or the golf cart controller 52 may facilitate control of the battery 14, the charger 16, and the electric motors 68.

In the illustrated embodiment, the wiring harness 50 includes a first electrical connection 58 (e.g., a wire/cable or wires/cables) between the battery 14 (e.g., the BMS 56) and the retrofit controller 18, and a second electrical connection 60 between the retrofit controller 18 and the golf cart controller 52. In some embodiments, the wiring harness 50 includes additional electrical connections, for example, between the battery 14 and the battery charger 16, between the battery charger 16 and the retrofit controller 18, and/or between the battery charger 16 and the golf cart controller 52.

The retrofit controller 18 is in communication with (e.g., communicatively coupled to) the battery 14, the battery charger 16, and the golf cart controller 52. The retrofit controller 18 includes a processing circuit 62 having a processor 64 and memory 66. The processing circuit 62 can be communicably connected to a communications interface such that the processing circuit 62 and the various components thereof can send and receive data via the communications interface. The processor 64 can be implemented as a general purpose processor, an application specific integrated circuit (“ASIC”), one or more field programmable gate arrays (“FPGAs”), a group of processing components, or other suitable electronic processing components.

The memory 66 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 66 can be or include volatile memory or non-volatile memory. The memory 66 can include database components, object code components, script components, or any other type of information structure for supporting the various activities and information structures described in the present application. According to some embodiments, the memory 66 is communicably connected to the processor 64 via the processing circuit 62 and includes computer code for executing (e.g., by the processing circuit 62 and/or the processor 64) one or more processes described herein.

The golf cart controller 52 is in communication with the battery 14, the battery charger 16, and one or more electric motors 68. The golf cart controller 52 includes a processing circuit 70 having a processor 72 and memory 74. The processing circuit 70 can be communicably connected to a communications interface such that the processing circuit 70 and the various components thereof can send and receive data via the communications interface. The processor 72 can be implemented as a general purpose processor, an application specific integrated circuit (“ASIC”), one or more field programmable gate arrays (“FPGAs”), a group of processing components, or other suitable electronic processing components.

The memory 74 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 74 can be or include volatile memory or non-volatile memory. The memory 74 can include database components, object code components, script components, or any other type of information structure for supporting the various activities and information structures described in the present application. According to some embodiments, the memory 74 is communicably connected to the processor 72 via the processing circuit 70 and includes computer code for executing (e.g., by the processing circuit 70 and/or the processor 72) one or more processes described herein. In some embodiments, the one or more electric motors 68 are configured to drive a traction or drive wheel(s) of the golf cart 54. The electric motors 68 are powered by the battery 14 and the speed of the electric motors 68 is controlled by the golf cart controller 52.

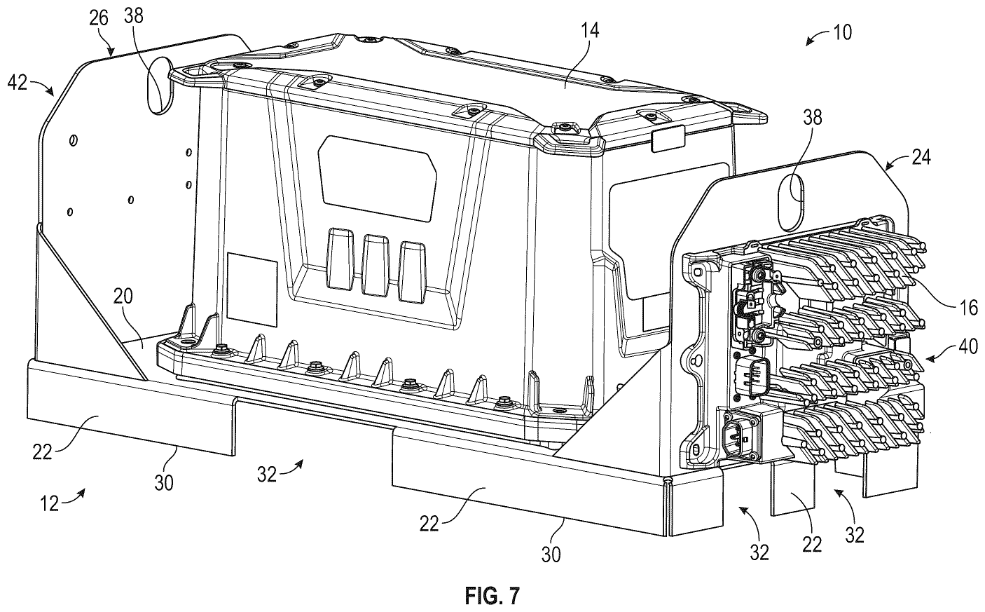

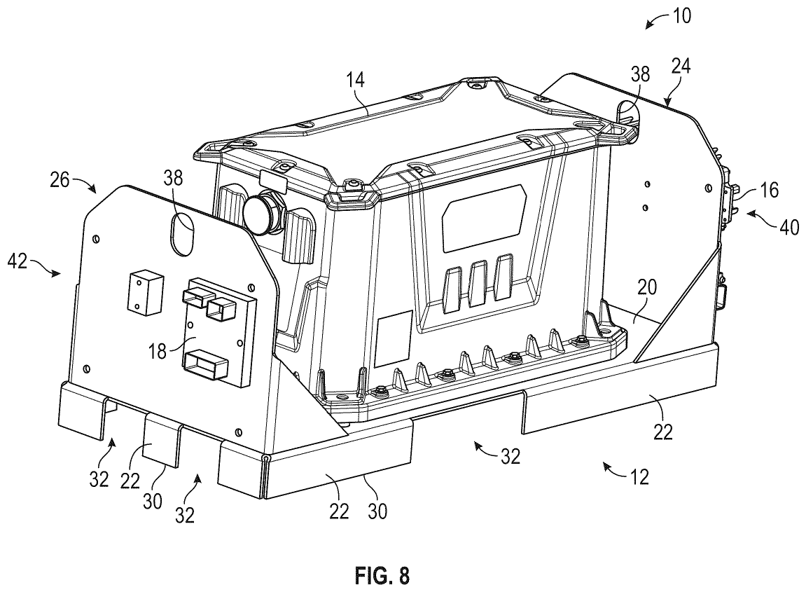

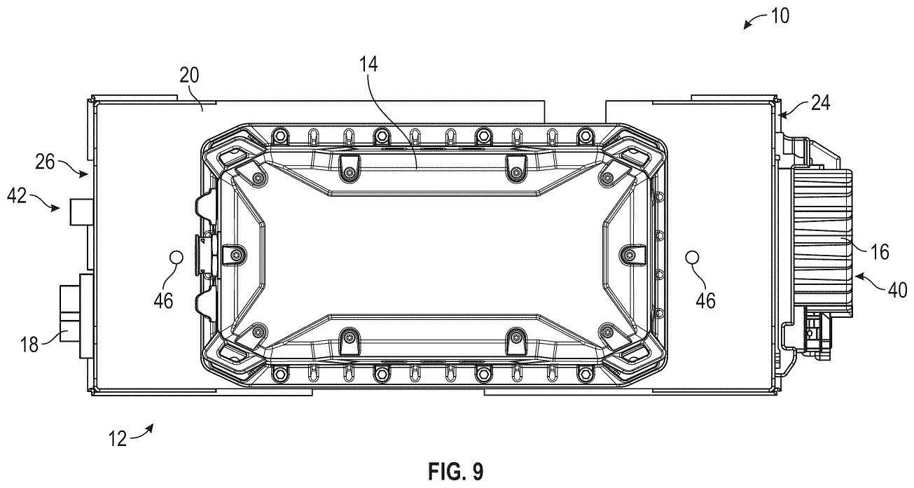

In some embodiments, the mounting of the battery charger 16 and the retrofit controller 18 on the frame assembly 12 may be modified to accommodate different mounting constraints in the battery compartment of a golf cart. For example, the battery charger 16 may be coupled to the first sidewall 24 or the second sidewall 26, and the retrofit controller 18 may be coupled to the first sidewall 24 or the second sidewall 26. With reference to FIGS. 7-9, the battery charger 16 and the retrofit controller 18 are mounted/coupled to an external surface of the first sidewall 24 and the second sidewall 26, respectively.

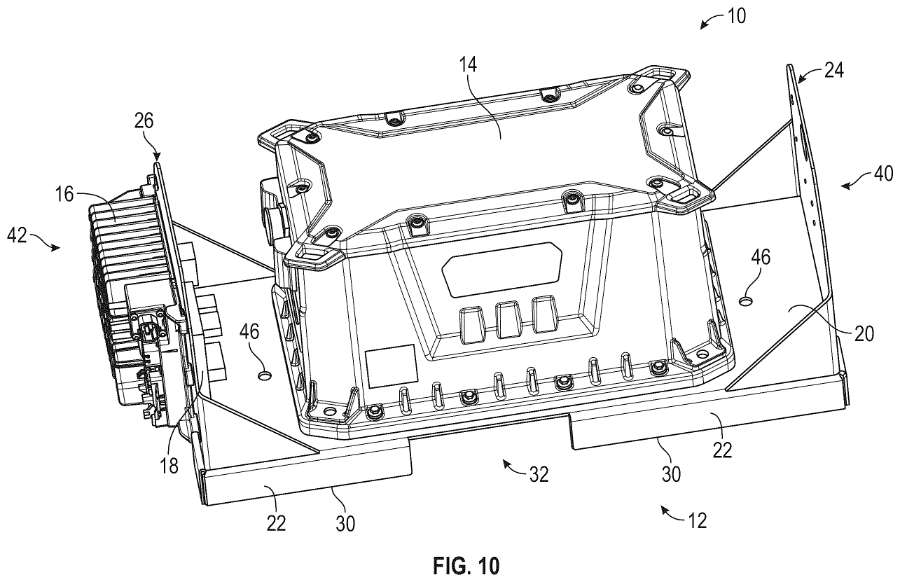

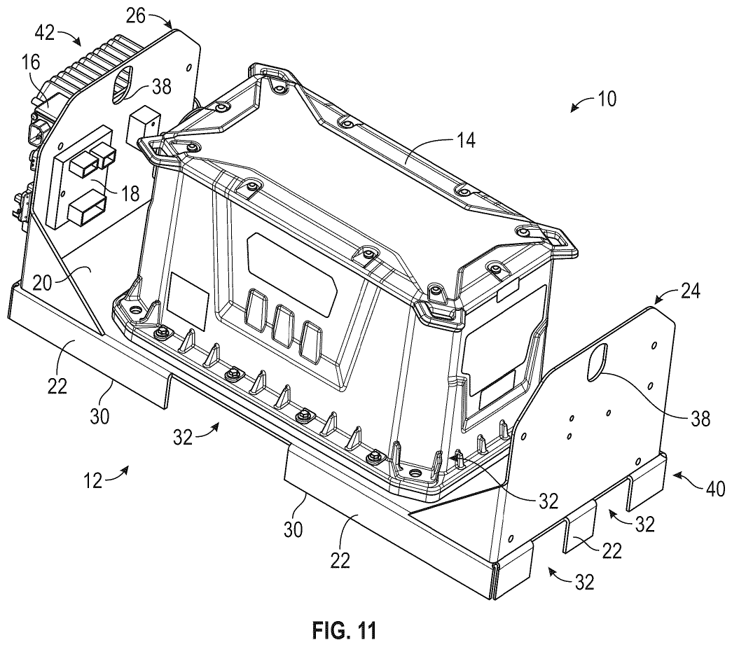

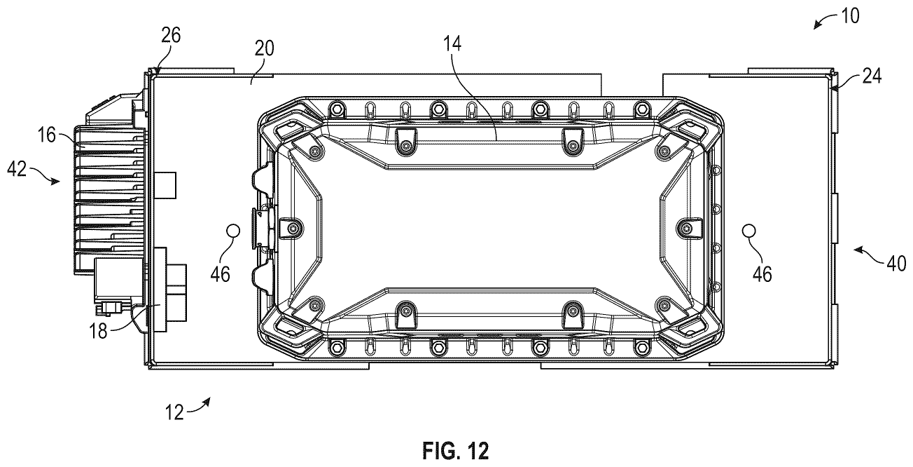

In some embodiments, the battery charger 16 and the retrofit controller 18 may be mounted to the same sidewall on the base assembly 12. FIGS. 10-12 show the battery charger 16 mounted/coupled to an external surface of the second sidewall 26 and the retrofit controller 18 mounted/coupled to an internal surface of the second sidewall 26. In some embodiments, the battery charger 16 is mounted/coupled to the internal surface of the second sidewall 26 and the retrofit controller 18 is mounted/coupled to the external surface of the second sidewall 26. In some embodiments, the battery charger 16 mounted/coupled to an external surface of the first sidewall 24 and the retrofit controller 18 mounted/coupled to an internal surface of the first sidewall 24. In some embodiments, the battery charger 16 is mounted/coupled to the internal surface of the first sidewall 24 and the retrofit controller 18 is mounted/coupled to the external surface of the first sidewall 24.

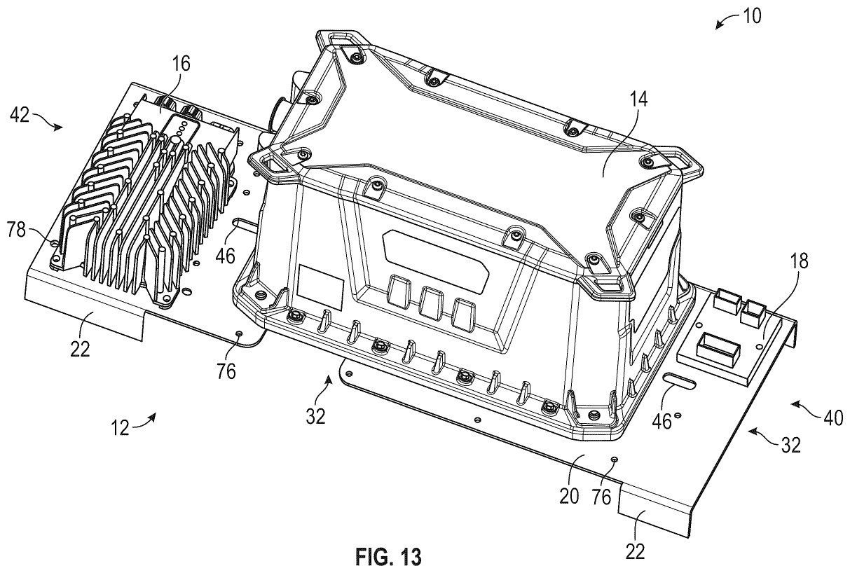

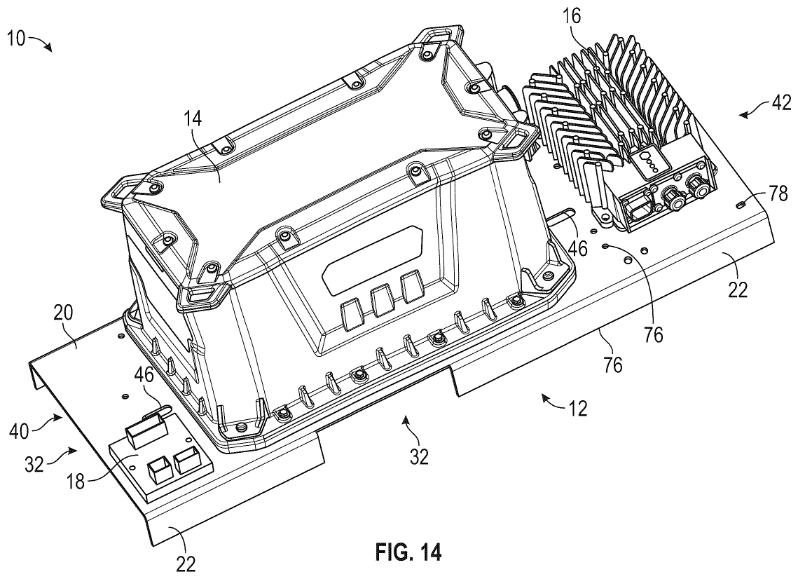

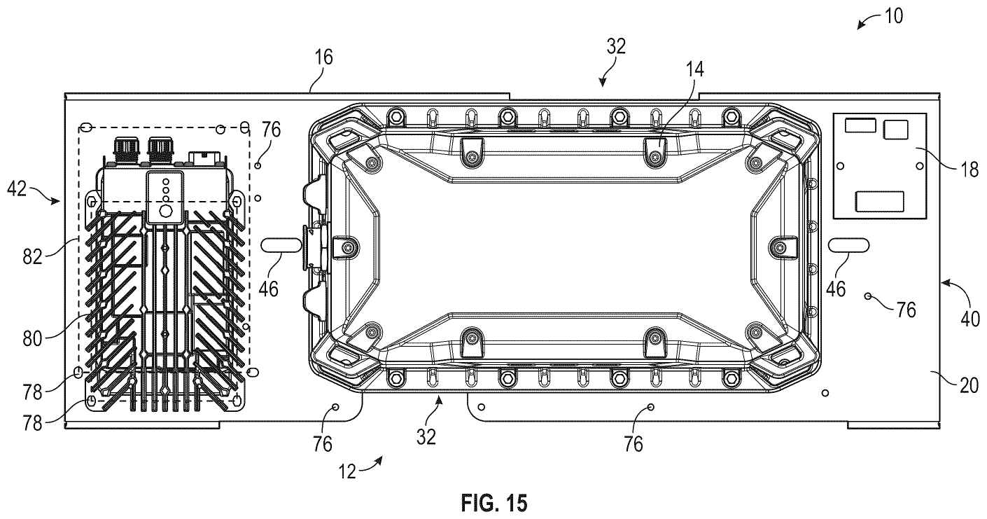

In some embodiments, the base assembly 12 may not include the first sidewall 24 and the second sidewall 26. For example, FIGS. 13-15 show the retrofit kit 10 where the first sidewall 24 and the second sidewall 26 are removed from the base assembly 12, and the battery charger 16 and the retrofit controller 18 are mounted and/or supported on the mounting surface 20. In the illustrated embodiment, the battery charger 16 and the retrofit controller 18 are arranged on opposing sides of the battery 14 (e.g., on longitudinally-opposing sides of the battery 14). In other words, the battery 14 is arranged between the battery charger 16 and the retrofit controller 18. The perimeter wall 22 is also removed from the first side 40 and the second side 42 of the base assembly 12. In general, the removal of portions of the perimeter wall 22, and both the first sidewall 24 and second sidewall 26 reduce the amount of material required to fabricate the base assembly 12 and reduce the manufacturing costs and overall weight of the base assembly 12.

With continued reference to FIGS. 13-15, the mounting surface 20 includes the mounting apertures 46, a plurality of wiring apertures 76, and a plurality of charger apertures 78. The plurality of wiring apertures 76 provide mounting locations for wire routing (e.g., clips, wiring harness mounts, etc.) to aid in routing wires in the wiring harness 50. The plurality of charger apertures 78 provide mounting locations for various sizes of the battery charger 16. For example, the plurality of charger apertures 78 include a first mounting pattern 80 for a first size of the battery charger 16 (i.e., the size illustrated in FIGS. 13-15) and a second mounting pattern 82 for a second size of the battery charger 16 (e.g., a size larger than the first size).

In some embodiments, the base assembly 12 does not include the perimeter wall 22, the first sidewall 24, and the second sidewall 26, as shown in FIG. 16. In this embodiment, the base assembly 12 defines a planar plate with the mounting surface 20 arranged on an upper side of the base assembly 12 and the bottom surface 36 arranged on a lower side of the base assembly 12.

The various embodiments of the base assembly 12 illustrated and described herein may be tailored to a particular geometry associated with the battery compartment on a golf cart. FIGS. 17-19 show an exemplary embodiment of a battery compartment 84 on a golf cart. In the illustrated embodiment, the battery compartment 84 defines a cavity that is generally in the shape of a rectangular prism. Conventional battery compartments on golf carts are designed to hold a plurality of lead acid batteries. The retrofit kit 10 is designed to occupy the mounting envelop (e.g., mounting volume) previously occupied by the lead acid batteries within the battery compartment 84, and facilitate efficient conversion from lead acid batteries to a lithium ion battery pack (e.g., the battery 14).

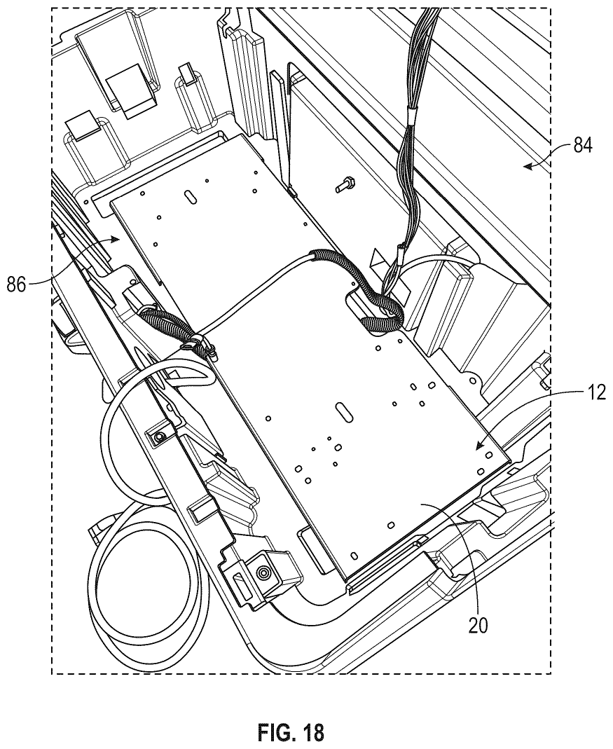

The base assembly 12 is shaped and dimensioned to fit within the battery compartment 84 and be supported on a frame or compartment mounting surface 86 (see, e.g., FIGS. 17 and 18). In some embodiments, the retrofit kit 10 may be installed within the battery compartment 84 as a single unit (e.g., with the battery 14, the battery charger 16, and the retrofit controller 18 installed on the base assembly 12). In the illustrated embodiment, the base assembly 12 is initially installed within the battery compartment 84 and coupled to the compartment mounting surface 86 (see, e.g., FIG. 18). Then the battery 14, the battery charger 16, the retrofit controller 18, and the wiring harness 50 are installed on the mounting surface 20 of the base assembly 12.

In general, the retrofit kit 10 is used in a process or method of retrofitting a power source on a golf cart (or a fleet of golf carts). The method or process begins by removing an existing battery on the golf cart (e.g., a lead-acid battery or a plurality of lead-acid batteries). After removing the existing battery from the compartment mounting surface 86 within the battery compartment 84, the base assembly 12 is installed within the battery compartment 84 so that the base assembly 12 is supported on the compartment mounting surface 86. With the base assembly 12 supported on the compartment mounting surface 86, the battery 14 is then installed on the base assembly 12 so that the battery 14 is supported on the mounting surface 20. The battery charger 16 and the retrofit controller 18 are then coupled to the base assembly 12 (e.g., one of the various locations described herein). With each of the battery 14, the battery charger 16, and the retrofit controller 18 installed on the base assembly 12, the wiring harness 50 is communicatively connected between both the battery 14 and the retrofit controller 18, and between the retrofit controller 18 and the golf cart controller 52.

While the retrofit kit 10 is described as being retrofitted onto a golf cart, the retrofit kit 10 may be implemented on other electrified chore products or “light” electrified vehicles, machines, or equipment, including outdoor power equipment, indoor power equipment, light vehicles, floor care devices, golf carts, lift trucks and other industrial vehicles, pavement surface preparation devices, recreational utility vehicles, industrial utility vehicles, lawn and garden equipment, and/or still other suitable vehicles, machines, or equipment. Outdoor power equipment may include lawn mowers, riding tractors, snow throwers, pressure washers, light towers, tillers, log splitters, walk-behind mowers, riding mowers, and turf equipment such as sod cutters, aerators, spreaders, sprayers, seeders, power rakes, and blowers. Indoor power equipment may include floor sanders, floor buffers and polishers, vacuums, etc. Recreational utility vehicles may include all-terrain vehicles (“ATVs”), utility task vehicles (“UTVs”), etc. Industrial utility vehicles may include forklifts, aircraft tugs, aerial lifts such as scissor lifts and boom lifts, etc.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the retrofit kit 10 as shown in the various exemplary embodiments is illustrative only. Additionally, any element disclosed in one embodiment may be incorporated or utilized with any other embodiment disclosed herein.

What is claimed is:

1. A battery retrofit kit for a golf cart, comprising:
a base including a mounting surface and supportable by the golf cart;
a lithium-ion battery supported on the mounting surface;
a battery charger coupled to the base; and
a retrofit controller coupled to the base.

2. The battery retrofit kit of claim 1, wherein the battery charger is coupled to and supported on the mounting surface.

3. The battery retrofit kit of claim 2, wherein the retrofit controller is coupled to and supported on the mounting surface.

4. The battery retrofit kit of claim 3, wherein the battery charger is arranged on the mounting surface on a first side of the lithium-ion battery, and wherein the retrofit controller is arranged on the mounting surface on a second side of the lithium-ion battery opposite the first side.

5. The battery retrofit kit of claim 1, wherein the retrofit controller is coupled to and supported on the mounting surface.

6. The battery retrofit kit of claim 1, further comprising a wiring harness including a first electrical connection between the lithium-ion battery and the retrofit controller and a second electrical connection between the retrofit controller and a golf cart controller.

7. The battery retrofit kit of claim 1, wherein the base includes a perimeter wall that extends away from the mounting surface in a first direction.

8. The battery retrofit kit of claim 7, wherein the base includes a sidewall and extending away from the mounting surface in a second direction opposite to the first direction, and wherein at least one of the battery charger and the retrofit controller is coupled to the sidewall.

9. The battery retrofit kit of claim 8, wherein the sidewall is a first sidewall and the base includes a second sidewall opposite the first sidewall and extending in the second direction, wherein the battery charger is coupled to the first sidewall, and wherein the retrofit controller is coupled to the second sidewall.

10. The battery retrofit kit of claim 8, wherein the battery charger is coupled to the sidewall.

11. The battery retrofit kit of claim 8, wherein the retrofit controller is coupled to the sidewall.

12. The battery retrofit kit of claim 1, wherein the mounting surface defines a plurality of charger apertures, and wherein the plurality of charger apertures defines a first mounting pattern defining a first size and a second mounting pattern defining a second size different than the first size.

13. A battery retrofit kit for a golf cart, comprising:
a base including a mounting surface and supportable by the golf cart;
a lithium-ion battery supported on the mounting surface;
a battery charger coupled to the mounting surface;
a retrofit controller coupled to the mounting surface; and
a wiring harness including a first electrical connection between the lithium-ion battery and the retrofit controller.

14. The battery retrofit kit of claim 13, wherein the wiring harness includes a second electrical connection between the retrofit controller and a golf cart controller.

15. The battery retrofit kit of claim 13, wherein the base includes a perimeter wall that extends away from the mounting surface.

16. The battery retrofit kit of claim 15, wherein the base includes a sidewall and extending away from the mounting surface in a direction opposite to the perimeter wall, and wherein at least one of the battery charger and the retrofit controller is coupled to the sidewall.

17. The battery retrofit kit of claim 13, wherein the mounting surface defines a plurality of charger apertures, and wherein the plurality of charger apertures defines a first mounting pattern having a first size and a second mounting pattern having a second size different than the first size.

18. A method of retrofitting a power source to a golf cart, the golf cart including a frame and a battery supported on the frame, the method comprising:
after removing the battery from the frame, supporting on the frame a base having a mounting surface;
supporting a lithium-ion battery on the mounting surface;
coupling a battery charger to the base; and
coupling a retrofit controller to the base.

19. The method of claim 18, wherein the golf cart further includes a golf cart controller, and wherein the method further comprises, with a wiring harness, communicatively connecting the lithium-ion battery and the retrofit controller, the wiring harness being configured to communicatively connect the retrofit controller with the golf cart controller.

20. The method of claim 18, wherein the mounting surface defines a plurality of charger apertures, and wherein the plurality of charger apertures defines a first mounting pattern and a second mounting pattern, and wherein coupling the battery charger to the base includes mounting the battery charger to the plurality of charger apertures in first mounting pattern or the second mounting pattern.
